(19) United States
(12) Patent Application Publication
(10) Pub. No.: US 2026/0079974 A1
(43) Pub. Date: Mar. 19, 2026

(54) SUPPLEMENTAL DATA RETRIEVAL AND MIXED GRANULARITY IN RETRIEVAL-AUGMENTED GENERATION (RAG)

(71) Applicant: HEWLETT PACKARD ENTERPRISE DEVELOPMENT LP, Spring, TX (US)

(72) Inventors: Cong Xu, Singapore (SG); Mainak Das, Bangalore (IN); Suparna Bhattacharya, Bangalore (IN); Sridhar Dorai, Bangalore (IN)

(21) Appl. No.: 18/936,731

(22) Filed: Nov. 4, 2024

(30) Foreign Application Priority Data
Sep. 19, 2024 (IN) 202441070847

(51) Int. Cl. G06F 16/33; G06F 16/383

(52) U.S. Cl. CPC G06F 16/3334; G06F 16/383

(57) ABSTRACT

Systems and methods are provided to implement improvements to the RAG process. For example, the system may receive a search query with a first search term and implement an intermediate matching process to identify semantically similar values between the first search term and terms in an existing knowledge base. The system may also determine at least one of the semantically similar values within a latent space proximity of a second search term. Based on the second search term, the system may retrieve an external data source utilizing a mixed granularity process.

### BACKGROUND

Retrieval-Augmented Generation (RAG) is a feature of artificial intelligence (AI) technology that references an authoritative knowledge base outside of its training data sources before generating a response. The AI technology model may be trained on large volumes of data and use billions of parameters to generate original output for various tasks. RAG extends these capabilities to specific domains without the need to retrain the model.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates one example of a network configuration that may be implemented for an organization, such as a business, educational institution, governmental entity, healthcare facility or other organization.

FIG. 2 is an example of an intermediate matching process in a RAG system, in accordance with examples discussed herein.

FIG. 3 illustrates a process of generating historical case data, in accordance with examples discussed herein.

FIG. 4 illustrates a mixed granularity process in a RAG system, in accordance with examples discussed herein.

FIG. 5 is an example computing component that may be used to implement various features of a set of models in accordance with examples discussed herein.

FIG. 6 is a computing component that may be used to implement examples of the disclosed technology.

The figures are not exhaustive and do not limit the present disclosure to the precise form disclosed.

### DETAILED DESCRIPTION

Traditional systems implement Retrieval-Augmented Generation (RAG) to enhance the accuracy and reliability of generative AI models with facts retrieved from various data sources. For example, a search query may be received that requests information. During retrieval of the information, the system may query external data, such as web pages, knowledge bases, and databases, and then retrieve the information from those data sources. The data may be augmented with context that enables a generative AI model (e.g., a large language model (LLM)) to generate more precise or informative responses.

Examples of the present disclosure provide various improvements to the system that implements the RAG process including, at least, the retrieval portion of the RAG process. For example, when a search query is received, the retrieval of the information may exclude a direct connection to the external data. Rather, the system may implement an intermediate matching process to identify semantically similar values in existing knowledge bases (e.g., historical case data), and utilize the information/values that is determined from the existing knowledge bases to retrieve the external data. This may create a new process from the search query to the intermediate matching process, and then to the external data. This process may help retrieve external data that is more accurate in responding to the search query and generate an actionable answer that matches the semantic structure of the query and the answer response.

Various implementations may help identify the link between the search query and the intermediate matching process (e.g., prior to accessing the external data). For example, the system may identify historical cases or other supplemental data that are semantically similar to the search query. This may help identify a semantic similarity between the search query and historical cases or other supplemental data. In another example, the system may ensure that the final answer is in close latent space proximity to the solution in the historical cases or other supplemental data within the latent space. This step confirms that the resolution is not only contextually relevant but also closely related to the solution vectors that have been effective in past cases.

In some examples, the intermediate matching process utilizes historical case data as supplemental data. The historical case data may comprise, for example, issue descriptions and resolutions in a computing environment. The issue descriptions may comprise plain language for a technical problem in the environment that are drafted by a human operator or otherwise generated answer associated with an identified issue. The resolution, like the issue description, may also comprise a plain language description, which identifies how the issues was resolved.

In some examples, the system utilizes a mixed granularity process to identify the relevancy of portions of available knowledge articles from the external data sources. For example, multiple hierarchical scores may be determined, including a first score to determine a relevancy of the entire document and a second score at a paragraph level of the entire document to identify fine-grain portions that are relevant to the response for the search query. The first score and the second score may be combined for a third score that ranks the particular fine-grain portion of the document for relevancy in responding to the search query.

In some examples, the mixed granularity process may rank both chunks of data from a document and the document overall to provide data based on both their intrinsic similarity and the overall relevance of the source document. The system may sort the chunks based on the final scores to determine a ranked list that balances specific content matches with broader document importance.

Technical benefits are realized throughout the disclosure. For example, the processes may enhance the RAG approach by incorporating an intermediate matching step. The intermediate matching step may circumvent the pitfalls of relying solely on semantic similarity and also ensure that the resolutions provided are anchored in the latent space relations established by supplemental data (e.g., historical case data). In another example, the system may be implemented with streaming log data/analytics. The system can identify system outages from log data that is received from a real-time streaming data source. The system may compare the log data with supplemental data, for example, using the semantic similarity between the two. The supplemental data may comprise a sequences of events and textual descriptions of event identifiers to help search existing data to find a solution to the issue. This can help analyze all data, not only analyzing the data that is more recent in time, and also translate log events with abbreviations into an understandable textual description of the event. In another example, the system can access a sales playbook and recorded historical conversations between sales associates and customers as supplemental data. The data may be used as an intermediate semantic search between customer queries and recordings/playbooks to access relevant knowledge articles related to current sales offerings. The knowledge articles may be more relevant to the intent of the initial query and lead to a better search results, thus reducing the need for further searching and reducing the communications transmitted via the network.

Technical benefits are also realized through the mixed granularity process. For example, by considering both document and chunk scores, the system can maintain context while still allowing for precise matching. Highly similar chunks of data from less relevant documents are less likely to dominate the results. Also, by adjusting the influence parameters (e.g., referred to as the alpha value and the beta value herein), the system can fine-tune the balance between document relevance and chunk similarity.

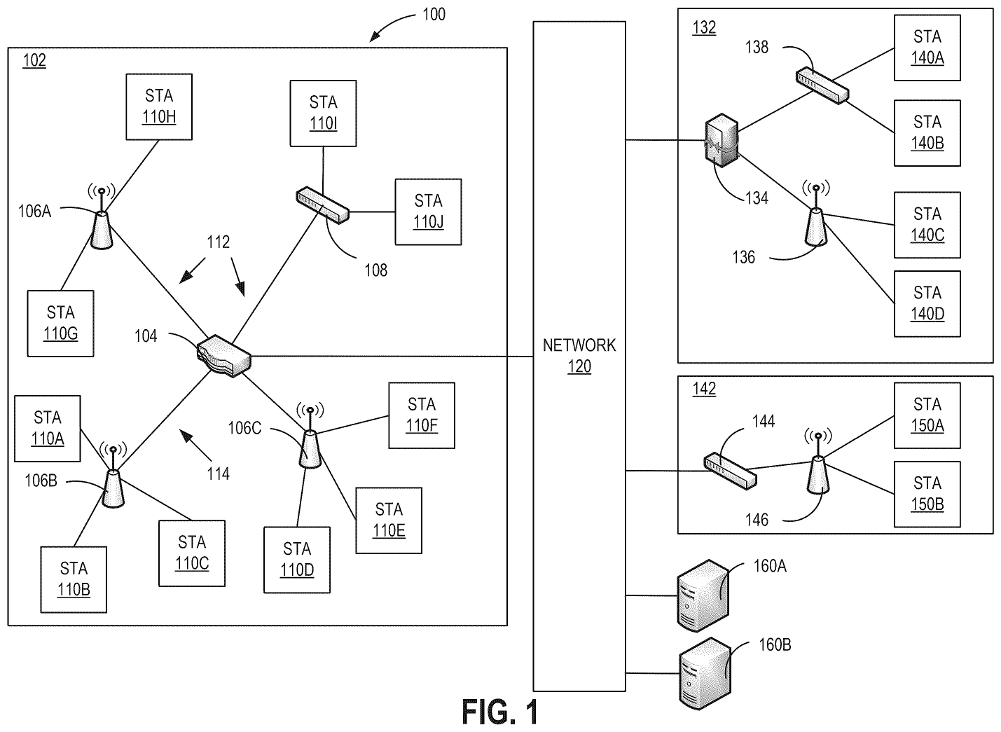

Before describing various examples of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. FIG. 1 illustrates an example of a configuration implemented with an organization having multiple users (or at least multiple client devices 110) and possibly multiple physical or geographical sites 102, 132, 142. Network configuration 100 may include primary site 102 in communication with network 120. Network configuration 100 may also include one or more remote sites 132, 142, that are in communication with the network 120. The query may be generated from any of multiple client devices 110 from any of the multiple physical or geographical sites 102, 132, 142, or may be generated from a remote location that monitors the client devices. In either of these examples, the system at primary site 102 receives the query for additional RAG analysis.

Primary site 102 may include a primary network, which may be an office network, home network, or other network installation, for example. The primary network may be a private network, such as a network that may include security and access controls to restrict access to authorized users of the private network. Authorized users may include employees of a company at primary site 102, residents of a house, customers at a business, for example.

In the example of FIG. 1, primary site 102 includes controller 104, which is in communication with network 120. Controller 104 may provide communication with network 120 for primary site 102. There may be other points of communication with network 120 for primary site 102 in addition to controller 104. Although single device associated with controller 104 is illustrated, primary site 102 may include multiple controllers and/or multiple communication points with network 120. In some examples, controller 104 may communicate with network 120 through a router. In other examples, controller 104 provides router functionality to the devices in primary site 102. In this specification, the word “tunnel” refers to an encapsulated mode of transporting data between AP and controller.

Controller 104 may be operable to configure and manage network devices, such as at primary site 102, and may also manage network devices at remote sites 132, 142. Controller 104 may be operable to configure and/or manage switches, routers, access points, and/or client devices connected to a network. Controller 104 may itself be, or provide the functionality of, an Access Point (AP).

Controller 104 may be in communication with one or more switches 108 and/or wireless Access Points (APs) 106a-c. Switches 108 and wireless APs 106a-c provide network connectivity to various client devices 110a-j. Using a connection to switch 108 or AP 106a-c, client device 110a-j may access network resources, including other devices on the (primary site 102) network and network 120.

Examples of client devices may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

Within primary site 102, switch 108 is included as one example of a point of access to the network established in primary site 102 for wired client devices 110i-j. Client devices 110i-j may connect to switch 108 and through switch 108, may be able to access other devices within network configuration 100. Client devices 110i-j may also be able to access network 120, through switch 108. Client devices 110i-j may communicate with switch 108 over a wired or wireless connection 112. In the illustrated example, switch 108 communicates with controller 104 over a wired or wireless connection 112.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h. In the example of FIG. 1, APs 106a-c can be managed and configured by controller 104. APs 106a-c communicate with controller 104 and the network over connections 112, which may be either wired or wireless interfaces.

Network configuration 100 may include one or more remote sites 132. Remote site 132 may be located in a different physical or geographical location from primary site 102. In some cases, remote site 132 may be in the same geographical location, or possibly the same building, as primary site 102, but lacks a direct connection to the network located within primary site 102. Instead, remote site 132 may utilize a connection over a different network, e.g., network 120. Remote site 132 such as the one illustrated in FIG. 1 may be a satellite office, another floor or suite in a building, for example. Remote site 132 may include gateway device 134 for communicating with network 120. Gateway device 134 may be a router, a digital-to-analog modem, a cable modem, a digital subscriber line (DSL) modem, or some other network device configured to communicate with network 120. Remote site 132 may also include switch 138 and/or AP 136 in communication with gateway device 134 over either wired or wireless connections. Switch 138 and AP 136 provide connectivity to the network for various client devices 140a-d.

In various examples, remote site 132 may be in direct communication with primary site 102, such that client devices 140a-d at remote site 132 access the network resources at primary site 102 as if these client devices 140a-d were located at primary site 102. In such examples, remote site 132 is managed by controller 104 at primary site 102, and controller 104 provides the necessary connectivity, security, and accessibility that enable the connection between remote site 132 and primary site 102. Once connected to primary site 102, remote site 132 may function as a part of a private network provided by primary site 102.

In various examples, network configuration 100 may include one or more smaller remote sites 142, comprising only gateway device 144 for communicating with network 120 and wireless AP 146, by which various client devices 150a-b access network 120. Examples of remote site 142 may represent, for example, an individual employee's home or a temporary remote office. Remote site 142 may also be in communication with primary site 102, such that client devices 150a-b at remote site 142 access network resources at primary site 102 as if these client devices 150a-b were located at primary site 102. Remote site 142 may be managed by controller 104 at primary site 102 to make this transparency possible. Once connected to primary site 102, remote site 142 may function as a part of a private network provided by primary site 102.

Network 120 may be a public or private network, such as the Internet, or other communication network to allow connectivity among various sites 102, 132, 142 as well as access to servers 160a-b. Network 120 may include third-party telecommunication lines, such as phone lines, broadcast coaxial cable, fiber optic cables, satellite communications, cellular communications, and the like. Network 120 may include any number of intermediate network devices, such as switches, routers, gateways, servers, and/or controllers, which are not directly part of network configuration 100 but that facilitate communication between the various parts of the network configuration 100, and between the network configuration 100 and other network-connected entities. Network 120 may include various servers 160a-b. In an example, servers 160a-b may comprise content servers that include various providers of multimedia downloadable and/or streaming content, including audio, video, graphical, and/or text content, or any combination thereof. Examples of content servers 160a-b include web servers, streaming radio and video providers, and cable and satellite television providers. Client devices 110a-j, 140a-d, 150a-b may request and access the multimedia content provided by content servers 160a-b.

In another example, servers 106a-b may comprise flow optimization service server that include various information for provisioning services to client devices 110a-j, 140a-d, 150a-b and optimizing traffic flows in accordance with the examples disclosed herein. Access points 106a-c, 136, and 146; switches 108; and gateway devices 134 and 144 may request or upload information, such as telemetry data, for optimizing rendering of services to client devices 110a-j, 140a-d, 150a-b. The information may include, but is not limited to, a measure or estimate of QoE on a per traffic flow basis (e.g., referred to herein as a QoE score); flow characteristics and other QoS measurements, such as but not limited to, jitter, delay, airtime, latency, etc.; analytics; transmission protocols (e.g., OFDMA and MU-MIMO), and the like. The information may be stored in a database, which can be communicatively coupled to servers 160a, 160b. In examples, servers 160a-b may be cloud-based, which would be understood by those of ordinary skill in the art to refer to being, e.g., remotely hosted on a system/servers in a network (rather than being hosted on local servers/computers) and remotely accessible.

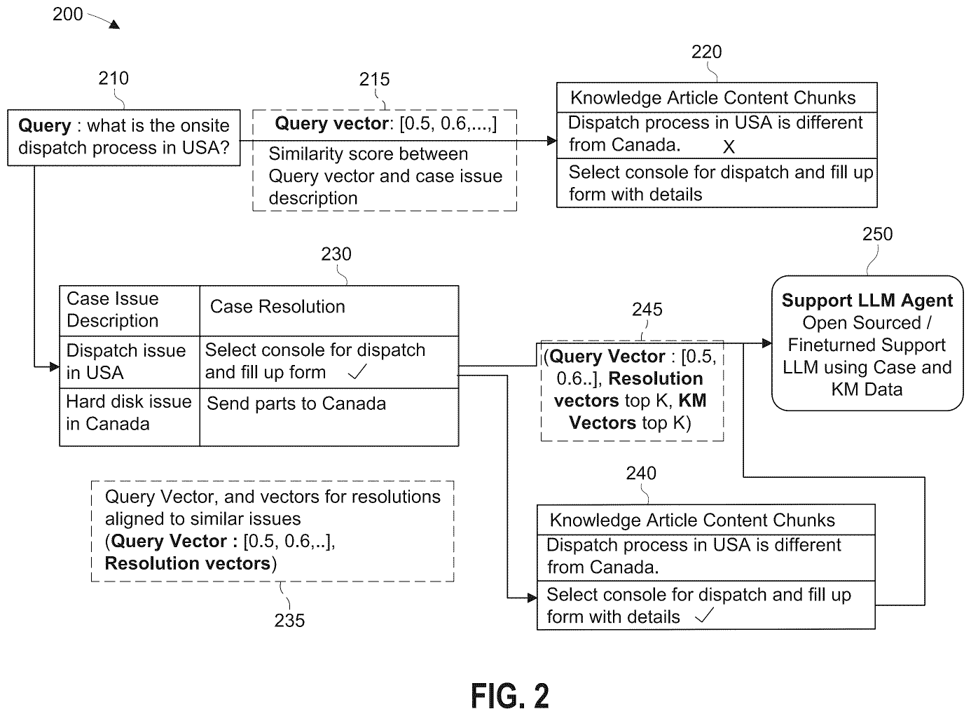

FIG. 2 is an example of an intermediate matching process in a RAG system, in accordance with examples discussed herein. In example 200, query 210 is received from a device (e.g., client devices 110 in FIG. 1) at a controller/central processor (e.g., controller 104 in FIG. 1) via a communication network (e.g., network 120 in FIG. 1).

User query 210 may comprise a request for information regarding various topics. In some examples, user query 210 is directed to a network issue and user query 210 may be submitted by a customer or a support engineer. Illustrative examples of user queries are provided throughout the disclosure. In example 200, user query 210 comprises “what is the onsite dispatch process in the USA?”

At block 215, a query vector is generated for user query 210, which corresponds to a numerical representation of user query 210. The query vector can encapsulate the semantic information of the query in a multi-dimensional space. Additional vectors may be computed for knowledge articles stored in a data store as discussed below (e.g., internal or external data stores at primary site 102 in FIG. 1).

In some examples, a knowledge article is a text-based document that includes a description of issues and corresponding solutions that occur in a data center, client site, or other location, sometimes referred to as case data. The knowledge article may be available as web page to support engineers and customers.

In generating each of the vectors, the system determines words or tokens of the original text (e.g., user query 210 and the knowledge articles) during a tokenization process. Each token may be converted into a numerical representation during an embedding process. The embeddings can be obtained from a pre-trained word embedding machine learning model or learned as part of a neural network architecture or transformers. The embeddings represent semantic and syntactic information about the words or tokens in the original text.

In some examples, an aggregation process and/or normalization process may be implemented. For example, the aggregation process may combine or aggregate the embeddings into a single vector representation. The system may average the embeddings of all words/tokens or, in some examples, the system may combine the embeddings as a weighted combination of the embeddings. In the normalization process, the single vector representation might be normalized to help ensure that the vector has a consistent scale and distribution.

The system may compute a similarity score between the vector for the user query and the vectors corresponding with the knowledge articles. In this illustration, the text of the knowledge articles include a text describing dispatch processes in the USA are different than Canada and a text describing a console for dispatch and a form with details.

At block 220, the knowledge article(s) with the similar score that exceeds a similarity threshold may be provided in response to user query 210. One or more knowledge article(s) may be provided.

At block 230, an intermediate matching process may be added between receiving user query 210 and providing the knowledge article(s), as shown in blocks 215, 220. For example, the intermediate matching process may access supplemental data associated with user query 210.

The supplemental data may correspond with various data sources. In the instance of case data associated with a data center, the supplemental data may comprise an issue description and a resolution associated with the issue. The issue description may correspond with an event in a data center or customer site, whereas the resolution may describe the steps to resolve and remediate the issue to remove the issue from the network. In some examples, the supplemental data comprises a description of interactions between support engineers and customers that occurred within the network environment or occurred external to the network environment with an external data source (e.g., in a Customer Relationship Management (CRM) system).

In another example, when user query 210 is associated with cases or technical issues in a computer network, the supplemental data may comprise historical case/issue data. In this illustration, the text of the supplemental data include a text describing dispatch issues in the USA (not a comparison of “dispatch processes” between USA and Canada, as shown in block 220) and a text describing a hard disk issue. Various types of data may be implemented in the system without diverting from the essence of the disclosure.

At block 235, vectors may be generated for each of the supplemental data. In generating each of the vectors, the system determines words or tokens of the original text (e.g., supplemental data) during a tokenization process. Each token may be converted into a numerical representation during an embedding process. The embeddings can be obtained from a previously-trained word embedding machine learning model or learned as part of a neural network architecture or transformers. The embeddings represent semantic and syntactic information about the words or tokens in the original text. In some examples, an aggregation process and/or normalization process may be implemented. For example, the aggregation process may combine or aggregate the embeddings into a single vector representation. The system may average the embeddings of all words/tokens or, in some examples, the system may combine the embeddings as a weighted combination of the embeddings. In the normalization process, the single vector representation might be normalized to help ensure that the vector has a consistent scale and distribution. The system may also compute a similarity score between the vector for the user query and the vectors corresponding with the supplemental data.

In some examples, a second search term may be identified in the supplemental data. The second search term may be identified from the semantically similar values within a latent space and, based on the second search term, the system may determine/retrieve an external data source. In some examples, the system may determine/retrieve an external data source based in part on user feedback in addition to the second search term.

In some examples, the supplemental data identified by the second search term is determined using a mixed granularity process. The mixed granularity process may combine multiple levels of specificity in identifying the appropriate external data source.

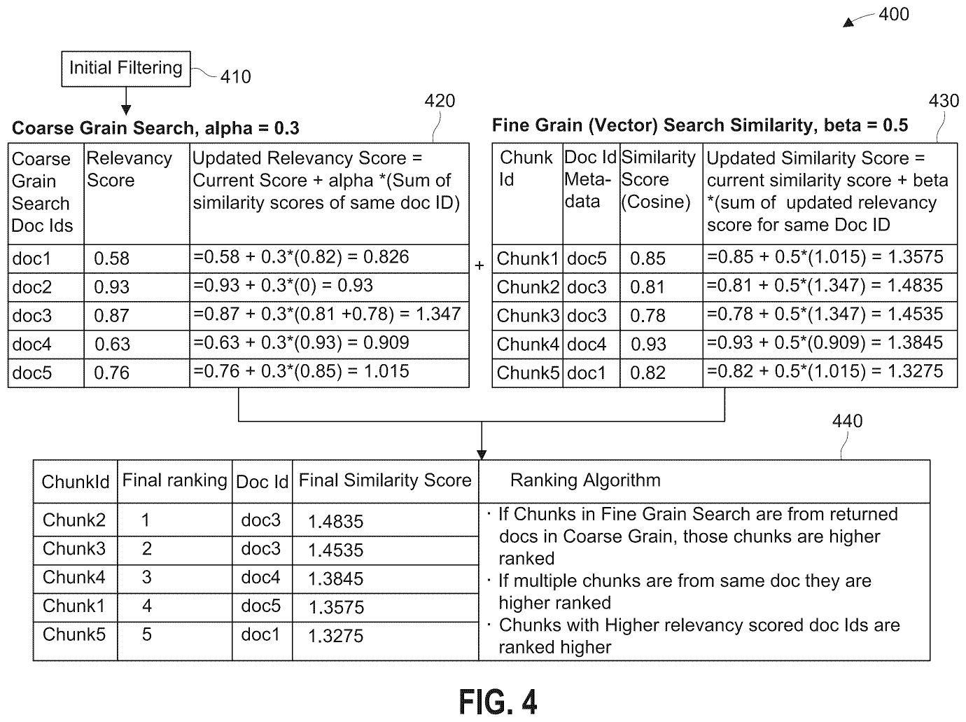

Various processes may be implemented for the mixed granularity process. For example, the mixed granularity process may determine multiple, hierarchical scores for external data sources. The scores may include a first score determining a relevancy of an entire document and a second score identifying fine-grain portions that are relevant to responding to the user query. The second score may be associated with the fine-grain portions may identify a paragraph level or other subset of portions of the entire document. In another example, the mixed granularity process implements an initial filtering process that may narrow a search space in both coarse-grain searching for the entire document and fine-grain searching for information at the paragraph level of the entire document. Additional detail associated with the mixed granularity process is provided with FIG. 4.

At block 240, the knowledge article(s) with the similar score that exceeds a similarity threshold may be provided in response to user query 210. The similarity score utilized by this process is based on a comparison between the supplemental data (block 230) and user query 210, rather than the comparison between the knowledge article(s) and user query 210. One or more knowledge article(s) may be provided.

At block 245, a numerical representation or vector representation of each of the knowledge articles is generated using a similar process as described herein. For example, in generating each of the vectors, the system determines words or tokens of the knowledge articles during a tokenization process. Each token may be converted into a numerical representation during an embedding process. The embeddings can be obtained from a pre-trained word embedding machine learning model or learned as part of a neural network architecture or transformers. The embeddings represent semantic and syntactic information about the words or tokens in the knowledge articles.

In some examples, an aggregation process and/or normalization process may be implemented. For example, the aggregation process may combine or aggregate the embeddings into a single vector representation. The system may average the embeddings of all words/tokens or, in some examples, the system may combine the embeddings as a weighted combination of the embeddings. In the normalization process, the single vector representation might be normalized to help ensure that the vector has a consistent scale and distribution. The system may compute a similarity score between the vector for the user query and the vectors corresponding with the knowledge articles.

At block 250, the similarity analysis may be provided to a device. The device may utilize the data generated at block 230 (using the second search term) or the data generated at block 240 to provide to the device.

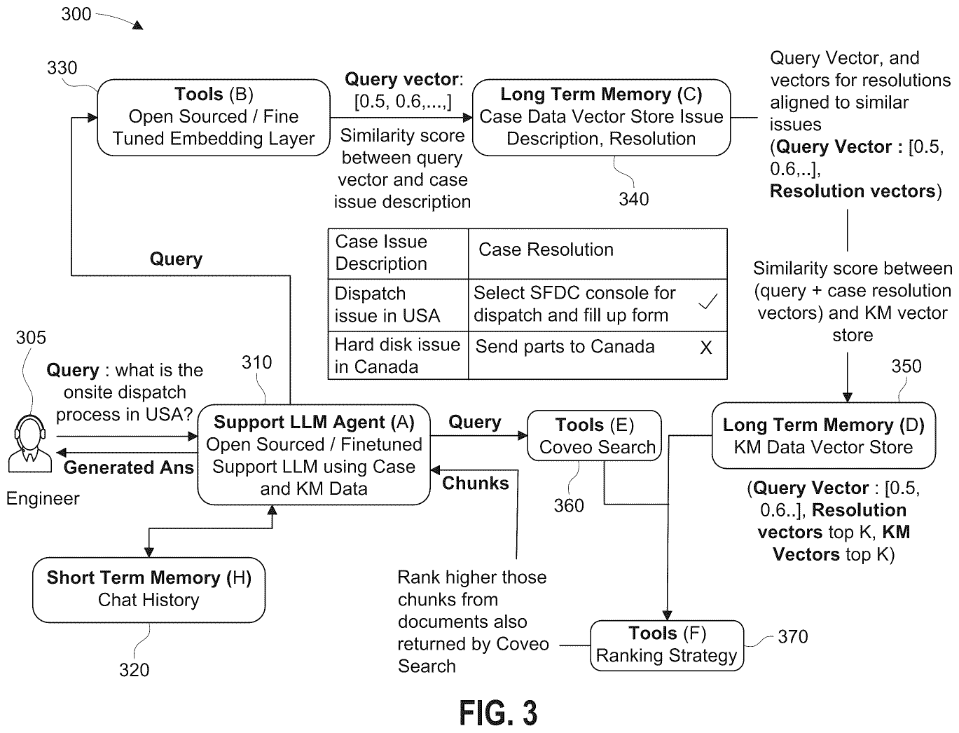

FIG. 3 illustrates a process of generating historical case data, in accordance with examples discussed herein. In example 300, an illustrative system is provided to show user 305 submitting a user query.

At block 310, the system may provide an LLM-based agent that can interface with user 305. The user may submit the user query via the user interface to the LLM-based agent. The LLM-based agent may be trained to initiate various processes, including submitting the user query to a set of systems, shown at blocks 315, 320, 325.

At block 320, the LLM-based agent may submit the user query to short term memory or other data store. Additional data may be stored with the query, including chat history between user 305 and LLM-based agent.

At block 330, the LLM-based agent may submit the user query to open source tools.

At block 340, the data may be stored in long term memory in association with the query vector that encapsulates the semantic information of the query in a multi-dimensional space.

At block 350, the query vector may be stored in long term memory in association with the vectors corresponding with the knowledge articles or other supplemental information determined by the system (e.g., during the intermediate matching process) and discussed herein.

At block 360, the LLM-based agent may submit the user query to a search tools. The search tool may receive the query and initiate a grain search associated with the terms in the query by utilizing a course-grain search process. In some examples, the course grain search process may be implemented by an external or third party searching tool.

At block 370, the system may proceed to initiate a ranking process. As described herein, the system may implement a mixed granularity process to identify the relevancy of portions of available knowledge articles from the external data sources. The scores may be determined, including a first score to determine a relevancy of the entire document and a second score at a paragraph level of the entire document to identify fine-grain portions that are relevant to the response for the user query. The first score and the second score may be combined for a third score that ranks the particular fine-grain portion of the document for relevancy in responding to the user query.

From the ranking tools, the rankings may be provided back to the LLM-based agent to provide to the user interface or audibly provide to user 305.

FIG. 4 illustrates a mixed granularity process in a RAG system, in accordance with examples discussed herein. In example 400, a mixed granularity process is shown. In some examples, the system utilizes a mixed granularity process to identify the relevancy of portions of available knowledge articles from the external data sources. The process may be implemented on various data, including a second search term that is within a latent space proximity to a semantically similar value of the user query. The data is received by the system (e.g., client devices 110 in FIG. 1) at a controller/central processor (e.g., controller 104 in FIG. 1) via a communication network (e.g., network 120 in FIG. 1).

At block 410, the system may implement an initial filtering process. The initial filtering may employ metadata filters to narrow down the search space in both fine-grain and coarse-grain retrievals. The initial filtering process can help identify relevant portions of documents and entire documents that may be relevant to provide in search results.

In some examples, the initial filtering may use metadata filters to narrow down the search space that it utilized in subsequent steps, including both fine-grain and coarse-grain searches. This step may help ensure that relevant chunks of data and the corresponding documents are considered by the system (e.g., for ranking).

At block 420, a first score may be determined on an entire document or a “course-grain search.” In some examples, the first score helps to determine a relevancy of an entire document for search results. The first score may be a combination of keyword matching and semantic understanding to generate the first score for each document.

As discussed herein, the system may compute a similarity score between the vector for the user query and the vectors corresponding with the knowledge articles. The similarity score may be calculated using a cosine similarity to measure how closely the article matches a given query or topic.

The system may also compute a relevancy score, which can use a combination of keyword matching and semantic understanding to determine the relevance of the document. The relevancy score is calculated by assigning a value based on the metadata of the document including the timestamp of generating/editing the document (e.g., freshness), keyword matches or user engagement (e.g., access history).

In example 400, identifiers to five documents are illustrated. When the alpha value is set to 0.3, the relevancy score for each document is added to the alpha value multiplied by the sum of the similarity scores of the same document. The aggregation of the relevancy score and the combined similarity scores may correspond with the updated relevancy score for the document as the “first score” described herein.

At block 430, a second score may be determined based on portions of the document or a “fine-grain search.” The process may determine portions of the entire document or user query, rather than the entire document that is utilized for the first score. The portions of the documents may be stored as vector embeddings and the process may calculate the distance or cosine similarity between them. The system may group similar chunks using a clustering process to generate clusters of data, and then rank the clusters to present the user with a diverse set of results.

The portions of the document may be detected based on pre-determined delimiters in the data. The delimiters may include, for example, a new line or set of spaces (e.g., identifying a paragraph separation), a period (e.g., identifying a sentence separation), a blank row (e.g., identifying a section separation within the document), or other data. The delimiters may be stored in a data store or delimiter library and accessed during the initial analysis of the document to identify the portions of the document that may be identified as relevant to the fine-grain search.

In example 400, identifiers to five chunks/clusters are illustrated. When the beta value is set to 0.5, a current similarity score is determined using processes described herein (e.g., using a cosine similarity). An updated similarity score may also be calculated. For example, the beta value may be multiplied by the sum of the updated relevancy score for the same document identifier (e.g., related to the first score in block 420), which is added to the current similarity score to generate the updated similarity score. The aggregation of the current similarity score and the beta value with the updated relevancy score may correspond with the updated similarity score for the document as the “second score”described herein.

In some examples, the second score is determined using vector space models for each of the documents. For example, the process may use clustering techniques to group similar portions of the documents as clusters and rank the clusters in relation to the relevancy to the user query.

In some examples, the system may determine/retrieve an external data source based in part on user feedback combined with the ranking process (e.g., hybrid ranking). For example, the process can determine the relevance scores for the documents and document portions, and also determine the relevance of each based on a user's assessment. As an illustrative example, if fine-grained retrieval (e.g., the second score) identifies a document that does not appear at the top of the coarse-grained results (e.g., the first score), the system can proactively query the user for validation via a user interface. The system can provide the filename and portions of the document at the user interface (e.g., the top five excerpts or paragraphs), and receive user feedback that indicates the document's relevance.

In some examples, the user feedback may be used to help train the system to better understand user needs and preferences. For example, the user feedback may be associated, through training, with features in the user query, terms, or other parameters (e.g., keyword density, semantic relatedness, user confirmation). The system can learn which parameters contribute most significantly to document relevance by correlating the feedback and updating hyperparameters for the model.

In some examples, the user interface may provide tools to determine immediate user interactions (e.g., as reward signals in reinforcement learning). The tools may comprise thumb ups/downs or inferred user emotions as illustrative examples. For example, once the user feedback includes one of the tools, the system can refine the model in real-time or offline in a separate process. For example, the system can implement a reinforcement learning algorithm that can adjust the ranking parameters based on the reward signals (e.g., received from user feedback or other user satisfaction metrics). In another example, the reinforcement learning may implement a continuous A/B testing process to compare different ranking strategies and incrementally update the system with the more successful models.

The second score may be generated in parallel/simultaneously with the first score. For example, instead of treating these scores in isolation, the system may let the first score and the second score influence each other. In some examples, the relevancy score for the document may be increased based on the similarity scores of its chunks. In other words, if a document contains highly similar chunks, its overall relevancy increases. In another example, the similarity score for the chunks may be adjusted based on the relevancy score for the document. In this case, the chunks from highly relevant documents get a boost in the ranking. This bidirectional influence can create a more holistic view of relevance and can help capture both broad document-level importance and specific chunk-level matches.

In some examples, the scores may be iteratively updated. First, the system may update the document relevancy scores based on the chunk similarity scores. The process may use the alpha value to control the influence of chunk scores on document scores. This loop may iterate through each chunk and find the associated document. Once the document is found, the process may add the fraction of the chunk's cosine similarity score (e.g., the alpha value multiplied by the cosine similarity value) to the document's relevancy score. Second, the system may update the similarity scores of the chunks based on their associated document's relevancy score. This update may utilities the beta value (e.g., 0.5) to help control the influence of document scores on chunk scores. This loop can create a second updated similarity score for each chunk by adding its original cosine similarity score to a fraction of its associated document's relevancy score (e.g., the beta value multiplied by the document relevancy score).

In response to the iterative updates described herein, in some examples, the system may identify the set of chunks that have been scored based on both their intrinsic similarity and the overall relevance of their source documents. The system may sort the chunks based on the final scores to determine a ranked list that balances specific content matches with broader document importance, as further described in block 440.

At block 440, the first score and the second score may be ranked. For example, the process may aggregate the first and second scores through a weighted value determination (e.g., using the alpha value and beta value described herein).

As shown, the fine-grained retrieval associated with the second score can include discrete data chunks including paragraphs or sentences. By assigning a weight to the similarity scores of these data chunks, the process may amplify the relevance score of a document proportionally with its ranking. This can help ensure that documents with more supporting evidence in a portion of the document are prioritized, thereby increasing the likelihood of providing the most pertinent documents in the search results. The weights can be dynamically adjusted based on the distribution of the similarity scores to balance between the fine-grained detail and the broader context provided by the coarse-grained results.

Various ranking models may be implemented. For example, a hybrid ranking model may be implemented that incorporates user feedback. This model may take into account the textual relevance derived from the automated retrieval processes and the user's assessment of the document's pertinence. In another example, the system can implement reinforcement learning algorithms that can adjust the ranking parameters based on the reward signals received from user satisfaction metrics or other feedback. The system may implement continuous A/B testing frameworks to compare different ranking strategies and incrementally update the system with the more successful/accurate models.

In example 400, five chunks/clusters are provided with the ranking and the final similarity score. The final similarity score is calculated using the processes described herein. For example, in line one, the final similarity score of 1.4835 equals the initial/current similarity score plus the beta value multiplied by the updated relevancy score for the corresponding document identifier (e.g., 0.81+0.5*1.347).

In some examples, the initial alpha value (used with block 420) and beta value (used with block 430) may be determined. In the examples illustrated herein, the alpha value is set to 0.3 and the beta value is set to 0.5. These values may be identified using the initial value determination process. For example, the system may create a retrieval dataset, where each entry in this dataset consists of a user query and its corresponding matched chunks. These matched chunks may be considered the ground truth or the ideal results that the system should return. The system may select a representative sample of entries from the dataset including for each sample query, and the system may identify a ranking with different combinations of alpha and beta values. For each combination, the retrieval accuracy may be measured. The measurement may determine how many of the ground truth matched chunks appear in the top N chunks of our ranked results (where N is a predefined number, such as top 10 or top 20). The system may also perform a grid search over a range of alpha and beta values (e.g., from 0 to 1 in increments of 0.1) or, in some examples, determine the values using an optimization process (e.g., Bayesian optimization). The system may identify the combination of alpha and beta values that maximizes the retrieval accuracy across the sample queries, which can help balance the influence of document relevancy and chunk similarity.

In some examples, the initial alpha value (used with block 420) and beta value (used with block 430) may be updated to updated alpha and beta values. For example, after ranking the documents and chunks, the system may provide a document with the highest updated relevancy scores to the user along with their query results (e.g., one or more documents). The system may provide a query to the user, e.g., “Are these documents relevant to your query?” The system may receive feedback from the user (e.g., yes/no). If the response is negative (i.e., the user indicates that the top documents are not relevant), the system may decrease the alpha value. The rationale is that a lower alpha value can reduce the influence of chunk similarity on document relevancy, potentially correcting for cases where highly similar but contextually irrelevant chunks have incorrectly boosted a document's score. In some examples, the system may implement A/B testing, where a subset of users interact with slightly different alpha and beta values. This can help the system compare performance and user satisfaction across different parameter settings in real-world conditions.

In some examples, the ranking process includes both broad and narrow documents that are relevant to the search query. For example, the documents may be received from diverse data sources and be stored in different formats (e.g., PDF, PPT, flow charts, etc.) so that the ranking process can include different types of documents. Corresponding chunks from each of the data sources may be considered. This can help ensure that the ranking process does not narrow down the search results excessively and omit documents that may not have ranked as highly but still contain pertinent information. In implementing the diversity factor, the ranking process can produce top results from a broad array of document types to help address varied user intents and interpretations of the search query.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

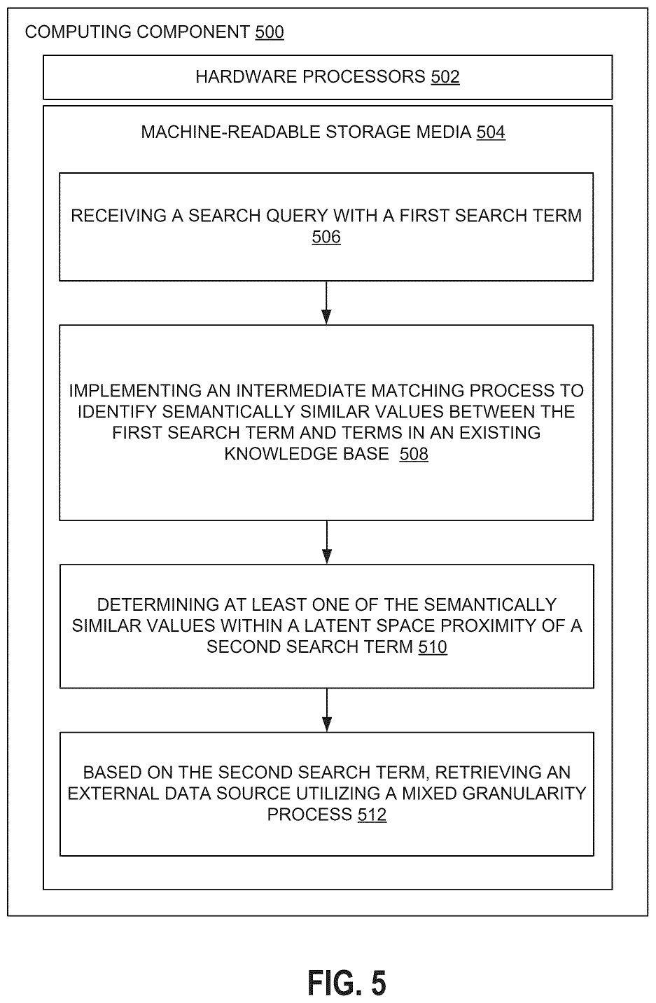

FIG. 5 illustrates a computing component that may be used to implement supplemental data retrieval and mixed granularity in RAG, in accordance with various examples of the disclosed technology. Referring now to FIG. 5, computing component 500 may be, for example, a server computer, a controller, or any other similar computing component capable of processing data. In the example implementation of FIG. 5, the computing component 500 includes hardware processor 502 and machine-readable storage medium 504.

Hardware processor 502 may be one or more central processing units (CPUs), semiconductor-based microprocessors, and/or other hardware devices suitable for retrieval and execution of instructions stored in machine-readable storage medium 506. Hardware processor 502 may fetch, decode, and execute instructions, such as instructions 506-512, to control processes or operations for supplemental data retrieval and mixed granularity in RAG. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-512.

Hardware processor 502 may execute instruction 506 to receive a search query with a first search term. For example, the query may comprise a request for information regarding various topics. In some examples, the query may be directed to a network issue and the query may be submitted by a customer or a support engineer.

Hardware processor 502 may execute instruction 508 to implement an intermediate matching process to identify semantically similar values between the first search term and terms in an existing knowledge base. In some examples, a query vector is generated for the received query, which corresponds to a numerical representation of query. The query vector can encapsulate the semantic information of the query in a multi-dimensional space.

In some examples, instruction 508 may comprise initiating a first semantic search of the search query with a query section of the existing knowledge base. For example, the first semantic search may identify semantically similar values in existing knowledge bases (e.g., historical case data) that can be utilized to retrieve additional data.

In some examples, instruction 508 may comprise determining a corresponding resolution section of the knowledge base as context to the first search term. For example, the resolution section may correspond with a close latent space proximity to the solution in the historical cases or other supplemental data within the latent space. This may help confirm that the resolution is not only contextually relevant but also closely related to the solution vectors that have been effective in past cases.

In some examples, the intermediate matching process utilizes historical case data as supplemental data in an existing knowledge base. The historical case data may comprise, for example, issue descriptions and resolutions in a computing environment. The issue descriptions may comprise plain language for a technical problem in the environment that are drafted by a human operator or otherwise generated answer associated with an identified issue. The resolution, like the issue description, may also comprise a plain language description, which identifies how the issues was resolved.

In some examples, instruction 508 may comprise generating a second search term by appending the corresponding resolution section to the first search term. For example, any of the terms in the resolution section may be appended to information associated with the first search term. In this example, the relevancy of the resolution may be added/appended to perform the directed search.

Hardware processor 502 may execute instruction 510 to determine at least one of the semantically similar values within a latent space proximity of the second search term. The determination may correspond with initiating a second search. In some examples, a second search term may be identified in the supplemental data from semantically similar values within a latent space. The second search term may be within a latent space proximity to a semantically similar value of the search query.

Hardware processor 502 may execute instruction 512 to retrieve an external data source utilizing a mixed granularity process based on the second search term. For example, the mixed granularity process may identify the relevancy of portions of available knowledge articles from the external data sources. The relevancy determination may include a first score to determine a relevancy of the entire document and a second score at a paragraph level of the entire document to identify fine-grain portions that are relevant to the response for the search query. The first score and the second score may be combined for a third score that ranks the particular fine-grain portion of the document for relevancy in responding to the search query.

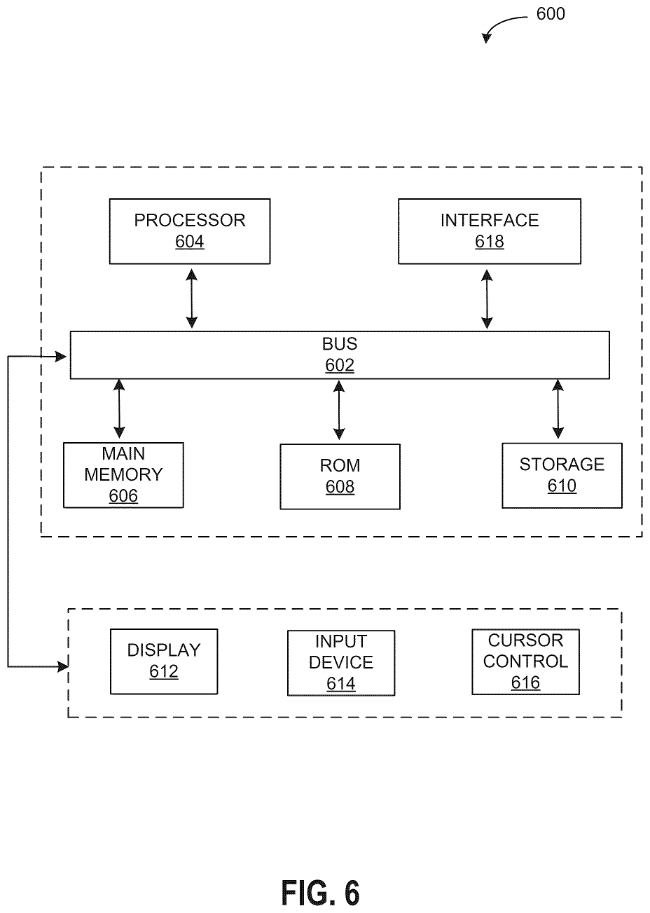

FIG. 6 depicts a block diagram of an example computer system 600 in which various examples of the disclosed technology described herein may be implemented. Computer system 600 includes bus 602 or other communication mechanism for communicating information, one or more hardware processors 604 coupled with bus 602 for processing information. Hardware processor(s) 604 may be, for example, one or more general purpose microprocessors.

Computer system 600 also includes main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

Computer system 600 further includes read only memory (ROM) 608 or other static storage device coupled to bus 602 for storing static information and instructions for processor 604. Storage device 610, such as a magnetic disk, optical disk, or USB thumb drive (Flash drive), etc., is provided and coupled to bus 602 for storing information and instructions.

Computer system 600 may be coupled via bus 602 to display 612, such as a liquid crystal display (LCD) (or touch screen), for displaying information to a computer user. The information may include, for example, the knowledge article or other search results illustrated in FIGS. 2 and 4. The display may also be configured to provide a user interface to collect user feedback that can be incorporated into the ranking process in mixed granularity.

In some examples, display 612, input device 614, and cursor control 616 may be utilized to send and receive user feedback that is used in the ranking process and help indicate the document's relevance.

Input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some examples, the same direction information and command selections as cursor control may be implemented via receiving touches on a touch screen without a cursor.

Computer system 600 may include a user interface module to implement a GUI to provide to display 612. The user interface module may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 600 may implement the techniques described herein using customized hard-wired logic, one or more ASICs or FPGAs, firmware and/or program logic which in combination with the computer system causes or programs computer system 600 to be a special-purpose machine. According to one example of the disclosed technology, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

Computer system 600 also includes interface 618 coupled to bus 602. Interface 618 provides a two-way data communication coupling to one or more network links that are connected to one or more local networks. For example, interface 618 may be an integrated services digital network (ISDN) card, cable modem, satellite modem, or a modem to provide a data communication connection to a corresponding type of telephone line. As another example, interface 618 may be a local area network (LAN) card to provide a data communication connection to a compatible LAN (or WAN component to communicate with a WAN). Wireless links may also be implemented. In any such implementation, interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 618, which carry the digital data to and from computer system 600, are example forms of transmission media.

Computer system 600 can send messages and receive data, including program code, through the network(s), network link and interface 618. In the Internet example, a server might transmit a requested code for an application program through the Internet, the ISP, the local network and interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method comprising:
receiving a search query with a first search term;
implementing an intermediate matching process to identify semantically similar values between the first search term and terms in an existing knowledge base by:
initiating a first semantic search of the search query with a query section of the existing knowledge base,
determining a corresponding resolution section of the knowledge base as context to the first search term, and
generating a second search term by appending the corresponding resolution section to the first search term;
initiating a second search to determine at least one of the semantically similar values within a latent space proximity of the second search term; and
based on the second search term, retrieving an external data source utilizing a mixed granularity process.

2. The computer-implemented method of claim 1, wherein the mixed granularity process determines multiple, hierarchical scores for the external data source, including a first score determining a relevancy of an entire document and a second score identifying fine-grain portions that are relevant to responding to the search query.

3. The computer-implemented method of claim 2, wherein the second score is associated with a paragraph level of the entire document.

4. The computer-implemented method of claim 2, wherein the first score and the second score are combined for a third score that ranks the fine-grain portion of the entire document for relevancy in responding to the search query.

5. The computer-implemented method of claim 1, wherein the mixed granularity process implements an initial filtering process that narrow down a search space in both coarse-grain searching for an entire document and fine-grain searching for information at a paragraph level of the entire document.

6. The computer-implemented method of claim 1, wherein the existing knowledge base comprises historical case data.

7. The computer-implemented method of claim 1, wherein the external data source is identified based in part on user feedback.

8. A computer system comprising:
a memory storing instructions; and
a processor communicatively coupled to the memory and configured to execute the instructions to:
receive a search query with a first search term;
implement an intermediate matching process to identify semantically similar values between the first search term and terms in an existing knowledge base by:
initiating a first semantic search of the search query with a query section of the existing knowledge base,
determining a corresponding resolution section of the knowledge base as context to the first search term, and
generating a second search term by appending the corresponding resolution section to the first search term;
initiate a second search to determine at least one of the semantically similar values within a latent space proximity of the second search term; and
based on the second search term, retrieve an external data source utilizing a mixed granularity process.

9. The computer system of claim 8, wherein the mixed granularity process determines multiple, hierarchical scores for the external data source, including a first score determining a relevancy of an entire document and a second score identifying fine-grain portions that are relevant to responding to the search query.

10. The computer system of claim 9, wherein the second score is associated with a paragraph level of the entire document.

11. The computer system of claim 9, wherein the first score and the second score are combined for a third score that ranks the fine-grain portion of the entire document for relevancy in responding to the search query.

12. The computer system of claim 8, wherein the mixed granularity process implements an initial filtering process that narrow down a search space in both coarse-grain searching for an entire document and fine-grain searching for information at a paragraph level of the entire document.

13. The computer system of claim 8, wherein the existing knowledge base comprises historical case data.

14. The computer system of claim 8, wherein the external data source is identified based in part on user feedback.

15. A non-transitory computer-readable storage medium storing a plurality of instructions executable by a processor, the plurality of instructions when executed by the processor cause the processor to:
receive a search query with a first search term;
implement an intermediate matching process to identify semantically similar values between the first search term and terms in an existing knowledge base by:
initiating a first semantic search of the search query with a query section of the existing knowledge base,
determining a corresponding resolution section of the knowledge base as context to the first search term, and
generating a second search term by appending the corresponding resolution section to the first search term;
initiate a second search to determine at least one of the semantically similar values within a latent space proximity of the second search term; and
based on the second search term, retrieve an external data source utilizing a mixed granularity process.

16. The non-transitory computer-readable storage medium of claim 15, wherein the mixed granularity process determines multiple, hierarchical scores for the external data source, including a first score determining a relevancy of an entire document and a second score identifying fine-grain portions that are relevant to responding to the search query.

17. The non-transitory computer-readable storage medium of claim 16, wherein the second score is associated with a paragraph level of the entire document.

18. The non-transitory computer-readable storage medium of claim 16, wherein the first score and the second score are combined for a third score that ranks the fine-grain portion of the entire document for relevancy in responding to the search query.

19. The non-transitory computer-readable storage medium of claim 15, wherein the mixed granularity process implements an initial filtering process that narrow down a search space in both coarse-grain searching for an entire document and fine-grain searching for information at a paragraph level of the entire document.

20. The non-transitory computer-readable storage medium of claim 15, wherein the existing knowledge base comprises historical case data.
